(19) United States
(12) Patent Application Publication
(10) Pub. No.: US 2003/0141472 A1
(43) Pub. Date: Jul. 31, 2003

(54) Injection valve

(76) Inventor: Patrick Mattes, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/220,693

(22) PCT Filed: Dec. 21, 2001
(86) PCT No.: PCT/DE01/04860

(30) Foreign Application Priority Data
Jan. 5, 2001 (DE) 101 00 390.0

(51) Int. Cl. F16K 31/12; B05B 3/04

(52) U.S. Cl. 251/57; 239/102.2

(57) ABSTRACT

An injection valve is proposed, including at least a nozzle module (2), which has a valve control piston (4), cooperating with a nozzle needle, and a valve control chamber (5) defined by a spring plate (21) and a face end (6) of the valve control piston (4), which valve control chamber communicates with a high-pressure supply line (9) via an inlet conduit (7) and is operatively connected, via an outlet conduit (24), with a valve control module (3) that is actuated by means of a piezoelectric actuator unit and is embodied in valvelike fashion and has at least one valve closing member (14), disposed in a valve chamber (18) and cooperating with at least one valve seat (16, 17); the nozzle needle is opened via a pressure reduction in the valve control chamber (5), effected by means of the valve control module (3) via the outlet conduit (24), and is closed via a filling of the valve control chamber (5). To achieve fast closure of the nozzle needle, the injection valve has means for filling the valve control chamber (5) via the inlet conduit (7) and the outlet conduit (24).

### PRIOR ART

The invention is based on an injection valve, in particular an injection valve for an internal combustion engine, as generically defined by the preamble to claim 1.

One such injection valve, which is known in the industry, is used particularly in conjunction with common-rail reservoir injection systems for Diesel engines. In such an injection valve, a valve control piston, which as a rule forms a structural unit with the nozzle needle, is surrounded at least partly by a chamber which via a so-called high-pressure supply line communicates with a high-pressure connection and contains fuel. A nozzle needle forming a structural unit with the valve control piston cooperates with a correspondingly embodied valve seat. Thus depending on the location of the valve control piston, via an opening of the injection valve leading to a combustion chamber of the internal combustion engine, the fuel injection into the combustion chamber can be controlled. The location of the valve control piston and thus of the nozzle needle is defined by means of a valvelike valve control module, which has an actuator unit, for instance a piezoelectric actuator unit.

In the injection valve of the type defined at the outset, in which the valve control module, which itself is embodied in valvelike fashion, cooperates with two valve seats, the boosting between the valve control piston and the valve control module is effected via a valve control chamber, disposed between these two parts, which communicates via an inlet throttle and the high-pressure supply line with a high-pressure connection that in turn communicates with a common high-pressure reservoir (common rail), and the valve control chamber also communicates with the valve control module via an outlet throttle and adjoins the free end of the valve control piston, that is, the end remote from the nozzle needle. This design enables a targeted pressure buildup and pressure drop, described hereinafter, in the valve control chamber that is tripped by means of the valve control module.

In the event that the valve closing member of the valve control module, which closing member cooperates with two valve seats, is located between the first and the second valve seat, the pressure prevailing in the valve control chamber can be dropped via the outlet throttle. The valve control piston is thus displaced in the direction of the valve control module, and as a result the opening leading into the combustion chamber of the engine is opened, and fuel is injected into the combustion chamber. As soon as the valve closing member of the valve control module contacts one of its two valve seats, the pressure in the valve control chamber rises, so that the valve control piston and thus the nozzle needle are moved into the closing position. This presses the nozzle needle into its seat, so that the injection valve is tightly closed off from the combustion chamber, and no fuel reaches the combustion chamber.

In the known injection valve of the type defined at the outset and described above, however, the problem exists that under some circumstances, the nozzle needle does not have a sufficient closing speed, and this can lead to disadvantages in terms of emissions from the engine involved.

### ADVANTAGES OF THE INVENTION

The injection valve of the invention having the characteristics of the preamble to claim 1, which for filling the valve control chamber via the first inlet conduit, having the inlet throttle, and the second outlet conduit, having the outlet throttle, has the advantage over the prior art that the pressure in the valve control chamber increases considerably faster than in the above-described injection valve of the prior art, since the filling of the valve control chamber when needed is effected not only via the inlet conduit but also via the outlet conduit.

This in turn means that the valve control piston and thus the nozzle needle are shifted much faster into their closing position. This furthermore lessens the variation from one mass-produced part to another; that is, for the same production tolerances, a higher number of usable parts can be made.

Moreover, filling the valve control chamber via the outlet throttle and inlet throttle means flatter characteristic curves for the quantity through the injection valve, that is, a reduction in tolerances in the injection quantity. The injection valve of the invention also leads to an improvement in least-quantity capability, that is, the capability of injecting the smallest possible quantities of fuel into the engine in controlled fashion.

In a preferred embodiment of the injection valve of the invention, the means for filling the valve control chamber are embodied such that the spring plate is embodied as displaceable at least regionally in the direction of the axis of the valve. The displacement occurring when the actuator unit is actuated takes place here preferably by means of the valve closing member, which establishes a communication between the valve chamber and the high-pressure supply line, so that the pressure prevailing in the high-pressure supply line is exerted into the valve control chamber both via the inlet conduit that has the inlet throttle and via the outlet conduit, which discharges into the valve chamber and has the outlet throttle. Thus a large quantity of fluid can be introduced into the valve control chamber within a short time in a simple way.

In an embodiment of the injection valve of the invention that is especially easy to realize, the communication which can be established by means of the valve closing member between the valve chamber and the high-pressure supply line is embodied as an annular gap, which is disposed between the spring plate and the valve body region that laterally defines the valve chamber. This annular gap preferably has a height of 5 to 10 μm.

To prevent major leakage as a consequence of the high pressure prevailing in the valve chamber when the spring plate is displaced, a line for relieving the valve chamber, which line as a rule leads to a fuel tank, can have a return throttle.

Further advantages and advantageous features of the subject of the invention can be learned from the description, drawing and claims.

### DRAWING

Two exemplary embodiments of the injection valve of the invention are shown schematically in simplified form in the drawing and will be described in further detail in the ensuing description. Shown are

FIG. 1, a region, relevant to the invention, of a first embodiment of an injection valve of the invention, in longitudinal section; and

FIG. 2, an alternative embodiment of an injection valve of the invention, in a view corresponding to FIG. 1.

### DESCRIPTION OF THE EXEMPLARY EMBODIMENTS

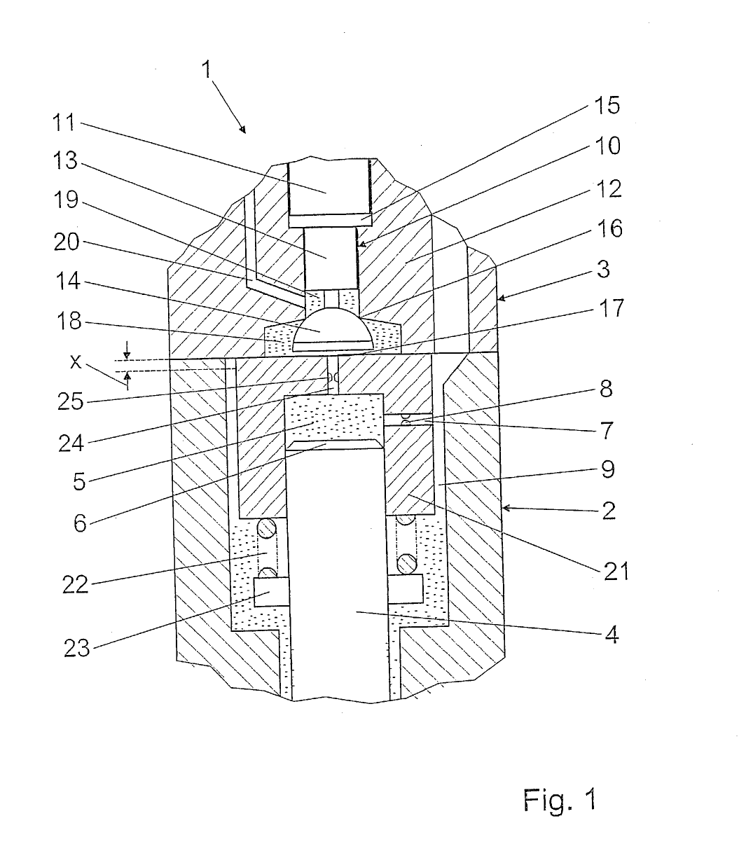

The exemplary embodiment shown in FIG. 1 is a fuel injection valve 1, which is intended for installation in an internal combustion engine, not shown here, of a motor vehicle and is embodied as a common rail injector, for injecting preferably Diesel fuel. To that end, as its essential structural units, the fuel injection valve 1 includes a nozzle module 2 and a valve control module 3. The nozzle module 2 includes a valve control piston 4, which is operatively connected to and forms a structural unit with a nozzle needle, not shown here, which controls an opening leading to a combustion chamber of the engine.

The location of the valve control piston 4 and thus of the nozzle needle is regulated via the pressure level in a valve control chamber 5, which adjoins the free face end 6 of the valve control piston 4 and which communicates, via an inlet conduit 7 in which a so-called inlet throttle 8 is disposed, with a fuel inlet conduit 9. The fuel inlet conduit 9 communicates with a high-pressure reservoir that is common to a plurality of injection valves and is known as a common rail. The fuel carried in the fuel inlet conduit 9 can thus be at a pressure of up to 1.5 kbar.

Also disposed in the nozzle module 2 in which the valve control piston 4 is disposed is a spring plate 21, in which the free end of the valve control piston 4 is guided, and which defines the valve control chamber 5. The spring plate 21 is braced via a spring 22 on a bearing face 23, which in turn is connected to the valve control piston 4.

Embodied in the spring plate 21 are the inlet conduit 7, oriented radially, and an outlet conduit 24, disposed axially, in which latter a so-called outlet throttle 25 is embodied, and which connects the valve control chamber 5 to a valve chamber 18 of the valve control module 3. The outlet conduit 24 is opened or closed via a valve closing member 14 disposed in the valve chamber 18.

The spring plate 21 rests with its face end toward the valve closing member 14 on a body 12 of the valve control module 3 and is embodied axially movably.

For adjusting an injection onset, injection duration, and injection quantity via force ratios in the fuel injection valve 1, a valve member 10 cooperating with the valve closing member is triggered, in the valvelike valve control module 3, via an actuator unit, not shown here and embodied for instance as a piezoelectric actuator, which unit is disposed on the side of the valve member 10 remote from the valve control piston 4 and thus from the combustion chamber.

The piezoelectric actuator engages a first piston 11, associated with the valve member 10; this piston is called the displacement piston. The valve member 10 is disposed axially displaceably in a longitudinal bore in a valve body 12 and includes besides the displacement piston 11 a second piston 13 or so-called actuating piston, which serves to actuate the valve closing member 14.

The actuation of the actuating piston 13 itself is effected via a hydraulic booster, which is embodied as a hydraulic chamber 15 and which, like a hydraulic coupler, transmits the axial deflection of the displacement piston 11 that is moved by means of the piezoelectric actuator. The hydraulic boost causes the actuating piston 13 to execute a stroke that is lengthened by the boosting ratio of the piston diameters, when the displacement piston 11 having the larger diameter has been moved a certain distance by the piezoelectric actuator.

The valve closing member 14 cooperates with a first valve seat 16 and a second valve seat 17; the first valve seat 16 is embodied as a ball seat, and the second valve seat 17 is embodied as a flat seat.

The valve chamber 18, in which the valve closing member 14 is disposed, is disconnected, when the piezoelectric actuator is not actuated, from a so-called outlet chamber 19 by means of the valve closing member 14 cooperating with the first valve seat 16; from this outlet chamber in turn, a return conduit 20, serving to relieve the outlet chamber 19 and the valve chamber 18, branches off and leads to a fuel tank, not shown here. A return throttle can be disposed in the return conduit 20.

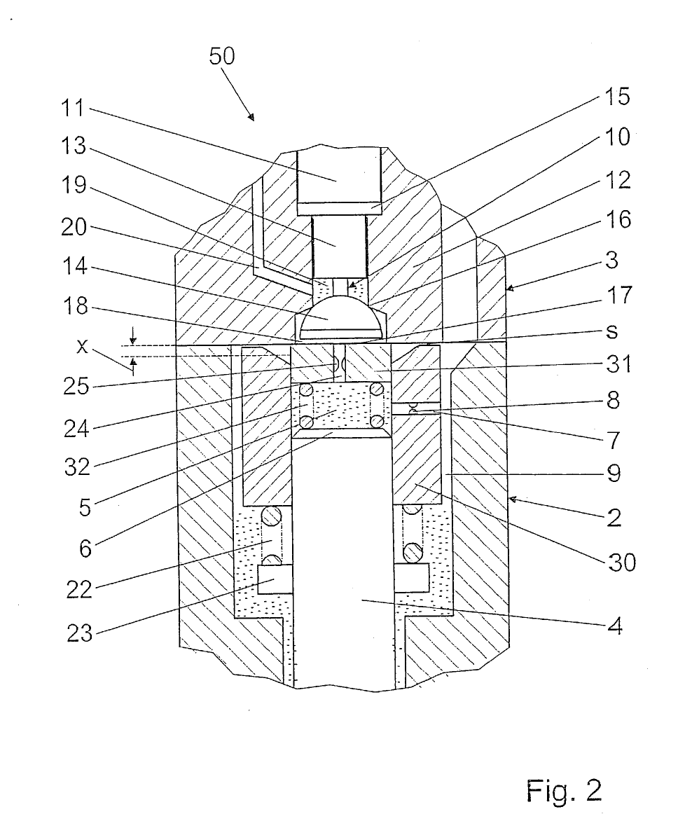

The exemplary embodiment shown in FIG. 2 also has an injection valve 50, in which for the sake of simplicity, the same reference numerals as in FIG. 1 are used for parts with the same function. The injection valve 50 differs from the injection valve of FIG. 1 in that it has a spring plate 21 that is not in one part but rather in two parts. The spring plate comprises an annular wall region 30, in which the inlet conduit 7, leading from the high-pressure supply conduit 9 to the valve control chamber 5 and having the inlet throttle 8 is disposed, and also comprises a platelike bottom region 31, which by means of a prestressing spring 32 braced on the face end 6 of the valve control piston 4 is pressed, when the actuator is not actuated, against the valve body region 12 of the valve control module 3. The outlet conduit 24 having the outlet throttle 25 and connecting the valve control chamber 5 to the valve chamber 18 is embodied in this platelike bottom region 31.

This construction makes it possible, upon actuation of the piezoelectric actuator, for only the platelike bottom region 31 of the spring plate to be displaced in the direction of the valve control piston 4 and thus in the direction of the axis of the injection valve 50, while conversely the annular wall region 30 of the spring plate remains stationary.

Furthermore, located between the annular wall region 30 of the spring plate and the valve body region 12, adjoining it, of the valve control module 3, there is a gap, marked “s” in FIG. 2, through which fuel at high pressure, carried in the high-pressure supply conduit 9, can flow in the direction of the platelike bottom region 31.

The injection valves described above in conjunction with FIGS. 1 and 2 each function as described below.

In the closed state of the fuel injection valve 1 and 50, that is, when there is no voltage applied to the piezoelectric actuator, the valve closing member 14, embodied here as a half-ball, is located on the first valve seat 16 associated with it. In this position, the valve closing member 14 is pressed against the valve seat 16, embodied here as a ball seat, by means of the high pressure or rail pressure prevailing in the high-pressure supply conduit 9 and acting on the valve closing member 14 via the inlet conduit 7, the valve control chamber 5 and the outlet conduit 24 having the outlet throttle 25. The valve closing member 14 is thus in its first blocking position.

If the injection valve 1 or 50 is to be opened, that is, if the injection nozzle closed by means of the nozzle needle, not shown here, is to be opened, then a voltage is applied to the piezoelectric actuator, whereupon the piezoelectric actuator suddenly expands in the axial direction, that is, the direction of the displacement piston 11. This displaces the displacement piston 11 in the direction of the actuating piston 13. This in turn trips a displacement, mediated via the hydraulic chamber 15, of the actuating piston 13 in the direction of the valve control piston 4. Thus the valve closing member 14 is likewise moved in the direction of the valve control piston 4, far enough that the circular face of the valve closing member 14 rests on the bottom region of the one-piece spring plate 21 (FIG. 1) or the platelike bottom region 31 of the two-piece spring plate 21 (FIG. 2), and the spring plate 21 as a whole, or the platelike bottom region 31 of the spring plate, is displaced far enough that a gap x, which has a height of 5 to 10 μm, is embodied between the spring plate and the valve body region 12 of the valve control module 3.

If the valve closing member 14 is resting on neither the first valve seat 16 nor the second valve seat 17, fuel located in the valve chamber 18 flows into the outlet chamber 19 and from there flows away into the fuel tank via the return conduit 20. Via the outlet conduit 24, in which the outlet throttle 25 is disposed, the valve control chamber 5 is thus relieved, so that the pressure in this control chamber drops, and the valve control piston 4 is displaced in the direction of the valve control module 3. As a result, the opening leading to the engine combustion chamber is uncovered, so that fuel that is at high pressure and is carried in the high-pressure supply conduit 9 is injected into the combustion chamber.

If the valve closing member 14 is resting on its second valve seat 17, and the spring plate 21 or the bottom region 31 of the spring plate, as applicable, is displaced in the direction away from the valve body region 12, the rail pressure prevailing in the high-pressure supply conduit 9 can build up again in the valve control chamber 5. In the injection valve of the invention, this is effected on the one hand via the inlet conduit 7 and on the other via the outlet conduit 24. This is assured by the provision that the above-described annular gap x opens by means of the valve closing member 14, and thus the rail pressure acts on the valve control chamber 5 via the outlet conduit 24 as well. The prerequisite for this is naturally that the second valve seat 17 not be embodied as a tight seat, but that instead the rail pressure can be exerted into the outlet conduit 24 via a gap.

Because the rail pressure is exerted into the valve control chamber 5 via two conduits, the pressure in the valve control chamber 5 builds up at a high speed, which in turn leads to a fast closing motion of the valve control piston 4 and thus of the nozzle needle connected to it.

If the voltage applied to the piezoelectric actuator is disrupted, then the displacement piston 11 is returned in the direction of the actuator, and as a result the pressure prevailing in the hydraulic chamber 15 is reduced, and the valve member and thus the actuating piston 13 are likewise moved in the direction of the piezoelectric actuator, until the valve closing member 14 comes to rest in the first valve seat 16. In the transition period, the pressure prevailing in the valve control chamber 18 drops again, and as a result the valve control chamber is again relieved, and the nozzle needle opens.

The invention can be used not only in the common rail injectors described here as a preferred field of use, but in general in fuel injection valves, optionally including those with a so-called single-seat final control element.

1. An injection valve, in particular for an internal combustion engine, including at least a nozzle needle (2), which has a valve control piston (4) that cooperates with a nozzle needle and a valve control chamber (5), which control chamber is defined by a spring plate (21) and a face end (6) of the valve control piston (4) and which communicates, via a first inlet conduit (7), provided with an inlet throttle (8), with a high-pressure supply line (9) and is operatively connected, via a second outlet conduit (24), provided with an outlet throttle (25), with a valve control module (3), actuated by means of an in particular piezoelectric actuator unit and embodied in valvelike fashion, which valve control module has at least one valve closing member (14), disposed in a valve chamber (18) and cooperating with at least one valve seat (16, 17), wherein the nozzle needle is opened via a pressure reduction, effected by means of the valve control module (3), in the valve control chamber (5) via the outlet conduit (24) that has the outlet throttle (25), and is closed via a filling of the valve control chamber (5) and thus a pressure increase therein, characterized by means for filling the valve control chamber (5) via the inlet conduit (7), having the inlet throttle (8), and the outlet conduit (24), having the outlet throttle (25).

2. The injection valve of claim 1, characterized in that the means for filling the valve control chamber (5) are embodied such that the spring plate (21; 30, 31) is displaceable at least regionally in the direction of the axis of the valve.

3. The injection valve of claim 2, characterized in that for the at least regional displacement of the spring plate (21; 30, 31) effected when the actuator unit is actuated, the valve closing member (14) acts on the spring plate (21; 30, 31).

4. The injection valve of claim 3, characterized in that when the actuator unit is actuated, a communication between the valve chamber (18) and the high-pressure supply line (9) is established by means of the valve closing member (14).

5. The injection valve of claim 4, characterized in that the communication between the valve chamber (18) and the high-pressure supply line (9) is embodied as an annular gap (x), which is disposed between the spring plate (21; 30, 31) and the valve body region (12) that laterally defines the valve chamber (18).

6. The injection valve of claim 5, characterized in that the annular gap (x) has a height of approximately 5 to 10 μm.

7. The injection valve one of claims 1-6, characterized in that the spring plate includes an annular wall region (30), in which the inlet conduit (7) having the inlet throttle is embodied, and a platelike bottom region (31), in which the outlet conduit (24) having the outlet throttle (25) is embodied.

8. The injection valve of claim 7, characterized in that the platelike bottom region (31) of the spring plate is braced via a spring (31) on the end face (6) of the valve control piston (4).

9. The injection valve one of claims 1-8, characterized in that for pressure relief of the valve chamber (18), a relief line (20), in which a throttle is disposed, branches off downstream of the valve closing member (14).
